(19) United States
(12) Patent Application Publication
(10) Pub. No.: US 2026/0266367 A1
(43) Pub. Date: Sep. 10, 2026

(54) PLANETARY GEAR WITH A CARRIER POT AND DRIVE UNIT WITH SUCH A PLANETARY GEAR

(71) Applicant: ZF Friedrichshafen AG, Friedrichshafen (DE)

(72) Inventors: Sylva ROTHER, Kressbronn am Bodensee (DE); Frank SAUTER, Meckenbeuren (DE); Hermann LANZ, Frickingen (DE); Mario HOLDER, Tettnang (DE); Berthold SCHRAFF, Friedrichshafen (DE); Horst LEICHSENRING, Meinheim (DE)

(73) Assignee: ZF Friedrichshafen AG, Friedrichshafen (DE)

(21) Appl. No.: 19/541,979

(22) Filed: Feb. 17, 2026

(30) Foreign Application Priority Data
Feb. 17, 2025 (DE) 10 2025 105 756.7

(51) Int. Cl. F16H 57/08; F16H 1/28; F16H 57/02; F16H 57/04

(52) U.S. Cl. CPC F16H 57/082; F16H 1/28; F16H 57/02; F16H 57/042; F16H 2057/02034; F16H 2057/02043

(57) ABSTRACT

A planetary transmission with a planetary gearset (1) has a sun gear (2) configured to be drivingly connected to a drive machine (10), a ring gear (3) configured to be drivingly connected to a drive output shaft (15), and a planetary carrier (4) with a plurality of planetary gearwheels (5) arranged at least indirectly on it. The planetary carrier (4) is held immobilized on a housing (7) and is connected rotationally fixed to the housing (7) by means of a bridge pot (6) which spans axially across the planetary gearset (1).

### RELATED APPLICATIONS

This application claims the benefit of and right of priority under 35 U.S.C. § 119 to German Patent Application no. 10 2025 105 756.7, filed on 17 Feb. 2025, the contents of which are incorporated herein by reference in its entirety.

### FIELD OF THE DISCLOSURE

The invention relates to a planetary transmission with a bridge pot. In addition, the invention relates to a drive unit for a motor vehicle drivetrain having a planetary transmission of that type

### BACKGROUND

For example, DE 199 15 926 A1 discloses a drive arrangement for a motor vehicle, which comprises an internal combustion engine with a crankshaft which can be connected by way of an interposed clutch to a transmission input shaft of a change-speed transmission, and with an electric machine provided in the drive arrangement which comprises a stator and a rotor. To support its rotation speed, the electric machine is functionally connected via a step-down gear to the crankshafts and/or to the transmission input shaft. The step-down gear is in the form of a planetary gearset which comprises a sun gear, a ring gear and a number of planetary gearwheels. The sun gear is provided as the drive input shaft of the planetary transmission, the ring gear is the drive output shaft of the planetary transmission, and the planetary carrier is connected rotationally fixed to a housing.

### SUMMARY

The purpose of the present invention is to provide an improved planetary transmission for a drive unit of a motor vehicle drivetrain. In particular, the planetary transmission and the drive unit provided therewith should be more compact. This objective is achieved by the features specified herein. Advantageous embodiments will be apparent from the description given below and the figures.

According to a fist aspect, a planetary transmission with a planetary gearset is proposed. The planetary transmission comprises a sun gear designed to be drivingly connected to a drive machine. In addition, the planetary transmission comprises a ring gear designed to be drivingly connected to a drive output shaft. And the planetary transmission comprises a planetary carrier with a plurality of planetary gearwheels arranged at least indirectly on it. The planetary carrier is attached in a fixed position to a housing. For that purpose, the planetary carrier is connected rotationally fixed to the housing by means of a bridge pot (or carrier pot) which spans axially across the planetary gearset.

Accordingly, the bridge pot is arranged between the housing and the planetary carrier, in order to attach the planetary carrier to the housing in a fixed position. Thus, the planetary carrier is in particular permanently connected rotationally fixed to the housing. This can be done in that the planetary transmission is free from a clutch that can be released during the operation of the planetary transmission, between the housing and the planetary carrier.

The planetary gearwheels mesh, in particular on the one hand with the sun gear, and on the other hand with the ring gear, and are mounted rotatably on the planetary carrier. The bridge pot extends in particular from the drive input side to the drive output side of the planetary gearset and thus spans it axially. In this context “spans axially” means that the bridge pot extends axially along an outer periphery of the planetary gearset, from one end to the other end of the planetary gearset. Specifically, the bridge pot has a section that extends axially and is essentially sleeve-shaped, and a section that extends radially and is essentially of annular disk form, these being connected to one another.

Preferably, the planetary carrier is connected to the bridge pot in an interlocked manner. In that way they can be coupled detachably to one another. That can greatly simplify the assembly of the planetary transmission. During the assembly of the planetary transmission, the planetary gearset can be inserted into the bridge pot from one end thereof, after which the bridge pot is connected with interlock to the planetary carrier.

In an embodiment, the bridge pot has a first section for a rotationally fixed connection to the planetary carrier and a second section for a rotationally fixed connection to the housing. Preferably the first section is essentially sleeve-shaped and extends along an outer periphery of the planetary gearset, axially from one end to the other end of the planetary gearset. The connection to the planetary carrier can then be formed at a free end of the first section. Preferably, the second section is in the form of an annular disk and extends along an end face of the planetary gearset essentially in the radial direction. The connection to the housing can then be formed at a free end of the second section. In other words, the first section and the second section can be arranged at opposite ends of the bridge pot. In that way the structural space available can be used to the best effect.

In other words, the bridge pot is in particular a component of the planetary transmission which spans axially across the planetary gearset and holds the planetary carrier in a fixed position on the housing. The bridge pot consists specifically of a sleeve-shaped section that extends along the outer periphery of the planetary gearset, and an annular disk-shaped section which is arranged at an end of the planetary gearset. The bridge pot ensures a compact structure and makes possible a stable connection between the planetary carrier and the housing.

Preferably, the first section has a larger diameter than the second section. In that way the connection between the planetary carrier and the housing is optimized, in particular so that fitting space can be saved. Preferably, the contour of the bridge pot essentially follows the contour of the gearset, in such manner that the gearset is enclosed at least around an outer periphery and at one of the two ends of the bridge pot. Preferably, the first section and the second section are connected integrally with one another. The bridge pot can therefore be made monolithically. The bridge pot can then be made by deformation and/or by a machining process. For example, the bridge pot can be produced in the form of an aluminum pressure-diecasting. Alternatively, the first section and the second section can be connected to one another by a material-merging method such as welding. Then the first section can be made of sheet metal while the second section can be made as an ancillary component by deformation, casting and/or by a machining process.

In an embodiment, the bridge pot comprises the first section with inner teeth for the interlocked and at least rotationally fixed connection of the bridge pot to the planetary carrier. The planetary carrier then comprises in particular outer teeth which correspond to the inner teeth of the first section, by virtue of which the connection is completed. Preferably, the inner teeth are formed at the free end of the first section. The use of such teeth facilitates the fitting of the planetary carrier into the bridge pot.

The second section can have at least one bore, preferably several bores, to allow passage of a fastening element in each case, which serves for the rotationally fixed connection of the bridge pot to the housing. Such a fastening element can be, for example, a screw or a bolt. The housing then has further bores, in particular corresponding to the fastening elements, for example threaded bores by means of which the connection is completed. In particular, the at least one bore is formed in a reinforced area of the second section. The number of bores in the second section of the bridge pot can vary, as required. In particular, the bores are formed axially in the second section and are distributed uniformly in the circumferential direction.

The second section can have outer teeth for the interlocking and at least rotationally fixed connection of the bridge pot to the housing. In particular, the housing then has inner teeth that correspond to and cooperate with the outer teeth of the second section, by virtue of which the rotationally fixed connection is completed. In particular, the outer teeth of the bridge pot are formed in a reinforced area of the second section.

In an embodiment, at least one perforation is formed in the first section to allow passage of a lubricant. Preferably, several such perforations are provided. In particular, the at least one perforation is arranged so that when the planetary transmission is assembled and ready for operation, lubricant can flow out of the bridge pot. The at least one perforation can therefore be located on the underside of the bridge pot. The lubricant flowing through the planetary gearset to cool and lubricate it can then flow down and out of the bridge pot through the perforation.

In an embodiment, the bridge pot has at least one positioning element for aligning the bridge pot correctly relative to the housing. This facilitates the positionally correct fitting of the bridge pot onto the housing. In that way it is ensured that the bridge pot is always located in a predetermined position relative to the housing. In particular, the positioning element is provided so as to orientate the bridge pot relative to the housing in the circumferential direction or the radial direction. Preferably, the positioning element is formed on the second section and is designed to cooperate with a correspondingly formed and correspondingly positioned element on the housing. The correct positioning of the bridge pot on the housing is in particular advantageous when at least one perforation for the passage of lubricant is formed in a particular area of the bridge pot.

The positioning element of the bridge pot can be in the form of a recess in the bridge pot. Then, to align the bridge pot, a pin can be inserted both in the recess on the bridge pot and also into a bore in the housing. Such a recess is easy to produce. Accordingly, such positioning means can be made very inexpensively.

The positioning element of the bridge pot can be in the form of teeth on the bridge pot. The teeth can be made non-uniformly, so that they fit into corresponding teeth of the housing only when the bridge pot is in the correct position. By using teeth as the positioning element, positioning can be carried out in a single assembly step. For that purpose, the bridge pot can have a tooth gap of the teeth for aligning the bridge pot on the housing. This tooth gap is of a different shape from all the other tooth gaps of the teeth, for example it can be twice as large. In particular the tooth gap is filled by a tooth of a cooperating tooth array of the housing, which is of matching shape. The positioning element or tooth gap can in this case be formed is the aforesaid outer teeth on the second section of the bridge pot.

According to an embodiment, the planetary transmission comprises the drive machine, which is in the form of an electric machine. In that case, at least the planetary gearset is arranged radially inside the drive machine. Accordingly, at least the planetary gearset, i.e., the sun gear, the ring gear, and arranged between them the planetary gearwheels fitted onto the planetary carrier, are arranged axially overlapping and within the drive machine. By virtue of this stacking of the drive machine and the planetary gearset, axial fitting space is saved. Preferably, the bridge pot is also arranged radially inside the drive machine.

The sun gear is preferably provided as the drive input shaft of the planetary gearset and is designed to feed drive power from the electric drive machine. The ring gear is provided as the drive output shaft of the planetary gearset. It can therefore be coupled, at least indirectly, for example via a ring gear carrier, to a drive output shaft of the planetary gearset or to other transmission stages. Preferably however, the planetary transmission has no other planetary gearset. The planetary gearwheels mesh with the sun gear and the ring gear, so that the planetary carrier which supports the planetary gearwheels by means of planetary gearwheel bolts is stationary and is connected via the bridge pot to the housing or to a component itself in a fixed position relative to the housing.

A rotor of the electric drive machine is preferably permanently connected to the sun gear, at least in a rotationally fixed manner. That connection can be made directly. In this way the planetary transmission can form a very compact drive unit. In this case the rotor and the sun gear always rotate in the same direction and at the same rotation speed. That can be realized if the planetary transmission is free from a clutch and/or gear ratios that can be released during the operation of the planetary transmission, between the rotor and the sun gear.

According to a second aspect, a drive unit for a motor vehicle drivetrain is provided, such that the drive unit comprises the planetary transmission described according to the first aspect. The drive unit comprises the housing and the electric drive machine, which is arranged together with the planetary transmission in an inside space of the housing. The above definitions and statements concerning technical effects, advantages and advantageous embodiments of the planetary transmission according to the invention also apply correspondingly to the drive unit according to the invention.

Preferably, the motor vehicle is an electric vehicle or a hybrid vehicle. Depending on its design, the motor vehicle drivetrain can then be driven purely electrically or in combination with an internal combustion engine.

The drive unit can be a hybrid module for a motor vehicle hybrid drivetrain. The drive unit can then be designed to be connected to a power input of a multi-gear transmission of the drivetrain. In that way the drive unit can be arranged in the power flow of the drivetrain between an internal combustion engine and the multi-gear transmission of the drivetrain. Thereby, the drive unit can drive the vehicle instead of the internal combustion engine or together with the internal combustion engine, at least at times.

Likewise, it is possible for the drive unit to be used for driving the motor vehicle drivetrain alone or together with one or more further electric drive units. There is then no need for an internal combustion engine in the drivetrain.

The drive unit can be designed such that the electric drive machine can be used for driving and for recuperation, as necessary. The drive unit can comprise a control and regulation unit of its own for the electric drive machine. The drive unit can comprise an inverter and/or a converter of its own for supplying electric power to the electric drive machine. The drive unit can have a lubricant circuit of its own for lubricating the planetary transmission. The drive unit can have a heat exchanger of its own for cooling a lubricant of the planetary transmission. The drive unit can be made with a single gear; this means that the drive unit always provides a single, predetermined gear ratio between the input and the output. The drive unit can be flange-mounted onto a multi-gear transmission of the vehicle drivetrain, or it can be designed for flange connection to such a transmission, in particular on an output side of the drive unit. The multi-gear transmission can be a transmission of countershaft design. The drive unit can be flange-mounted onto an internal combustion engine of the vehicle drivetrain, or it can be designed for flange connection to such a combustion engine, in particular on the drive input side of the drive unit. The drive unit can comprise a clutch bell for accommodating a separator clutch. The clutch bell can be formed by the housing of the drive unit. The clutch bell can be designed to be flange-mounted onto the internal combustion engine. An inside space of the clutch bell for accommodating the separator clutch can be separated hermetically from the aforesaid inside space for accommodating the planetary gearset of the drive unit. The separator clutch can be designed for the optional coupling or decoupling of the drive unit to or from the internal combustion engine.

Preferably, the drive unit comprises only the one planetary gearset and only the one electric drive machine. This means that the drive unit has no other planetary gearsets and no other electric drive machines for driving the motor vehicle. Preferably, the drive unit has no switchable clutches. Thanks to these measures, the drive unit can be made very compact.

Basically the invention can also relate to a motor vehicle drivetrain of this type, which comprises all or some of the aforesaid features. The invention can also relate to a motor vehicle which has such a drivetrain.

### BRIEF DESCRIPTION OF THE DRAWINGS

Advantageous embodiments of the invention, which are explained below, are illustrated in the drawings in which the same or similar elements are denoted by the same indexes, and which show:

FIG. 1: A schematic representation of part of a planetary transmission,

FIG. 2: A schematic longitudinally sectioned representation of part of a planetary transmission configured as in FIG. 1,

FIG. 3: A perspective representation of a bridge pot according to FIGS. 1 and 2,

FIG. 4: Another perspective representation of the bridge pot according to FIG. 3,

FIG. 5: A schematic longitudinally sectioned representation of a further part of the planetary transmission according to FIGS. 1 and 2,

FIG. 6: A schematic transverse representation of part of the planetary transmission shown in FIG. 1, according to a further embodiment,

FIG. 7: A schematic longitudinally sectioned representation of part of the planetary transmission shown in FIG. 1, according to a further embodiment, and

FIG. 8: A schematic longitudinally sectioned representation of part of the planetary transmission shown in FIG. 1, according to a further embodiment.

### DETAILED DESCRIPTION

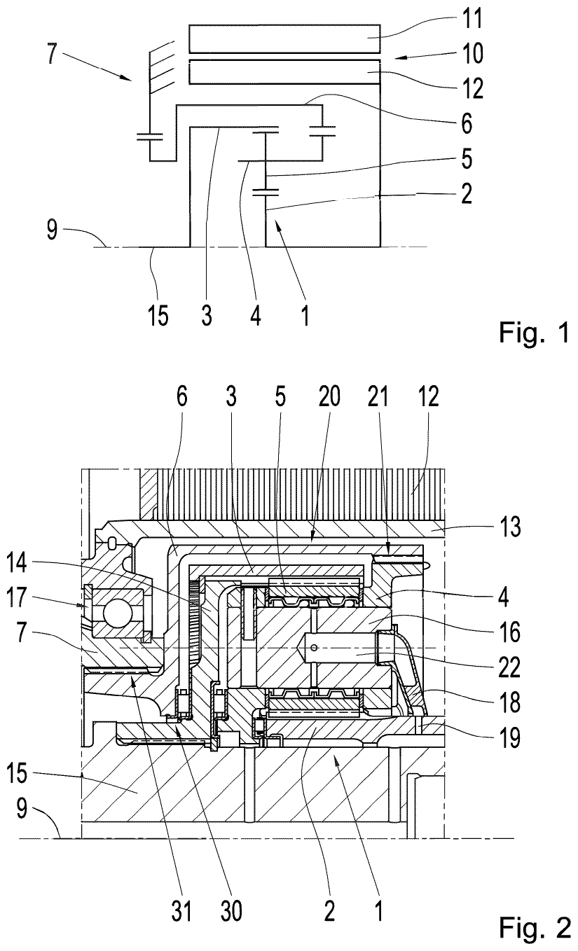

FIG. 1 shows a planetary transmission with an electric drive machine 10. The electric drive machine 10 comprises a stator 11 and a rotor 12. The planetary transmission also comprises a planetary gearset 1, which is arranged radially inside the drive machine 10. The planetary gearset 1 has a sun gear 2, a ring gear 3, and a planetary carrier 4 with a plurality of planetary gearwheels 5 arranged on it.

The main rotation axis of the planetary gearset 1 is indexed 9. This rotation axis 9 at the same time forms the longitudinal axis of the planetary transmission. Thus, spatial terms such as “axial”, “radial” or “in the circumferential direction” relate to this rotation axis 9 unless otherwise specified.

In this case, the planetary carrier 4 of the planetary transmission is attached by means of a bridge pot 6 in a fixed position on a housing 7. Thereby, the planetary carrier 4 and the bridge pot 6 are connected rotationally fixed to the housing 7 at all times. The bridge pot 6 spans across the planetary gearset 1 and extends from a first end of the planetary gearset 1 to the opposite, second end of the planetary gearset 1.

The planetary transmission preferably forms a drive unit for a motor vehicle drivetrain. Such a drive unit can serve for the hybridization of the drivetrain, in which an internal combustion engine is provided as an additional power source. In that case, the drive unit can be in the form of a hybrid module. For that purpose, the hybrid module can be arranged on a power input of a multi-gear transmission. However, the drive unit can also serve as the sole power source in a drivetrain of a motor vehicle. The drive unit then enables the drivetrain to be powered electrically, at least some of the time.

The housing 7 can be a housing of the drive unit and can accommodate the planetary transmission, so that the electric drive machine 10 and the planetary gearset 1 are arranged within an inside space of the housing 7. Preferably, the planetary transmission and the drive unit provided with it comprise only the electric drive machine 10 and the planetary gearset 1, i.e., with no further drive machine and no further planetary gearset.

In this case, the sun gear 2 is connected rotationally fixed and directly to the rotor 12 of the drive machine 10. Thus, no gear ratios or clutches are arranged between them. Accordingly, the sun gear 2 and the rotor 12 always have the same rotation direction and rotation speed. The ring gear 3 is connected rotationally fixed and directly to a drive output shaft 15. Thus, here too no gear ratios or clutches are arranged between them. Accordingly, the ring gear 3 and the drive output shaft 15 always have the same rotation direction and rotation speed.

The drive output shaft 15 preferably forms the drive output of the drive unit. If the drive unit is used as a hybrid module, the drive output shaft 15 leads, as a transmission input shaft, to a multi-gear transmission or it can be coupled at least rotationally fixed to such a transmission input shaft.

The sun gear 2 and the ring gear 3 rotate about the rotation axis 9 at different rotation speeds, whereas the planetary carrier 4 and the bridge pot 6 are fixed statically to the housing 7 and are therefore prevented from rotating. The bridge pot 6 makes possible a particularly compact structure of the planetary transmission and the drive device since it spans across the planetary gearset 1, and the planetary carrier 4, which extends on the drive input side out of the planetary gearset 1, is fixed on the drive output side statically to the housing 7. Furthermore, in that way an advantageous axial overlap of the planetary gearset 1 and the drive machine 10 is made possible, and this in particular saves axial fitting space.

FIG. 2 shows part of a longitudinal section through a planetary transmission made in accordance with FIG. 1. The bridge pot 6 has a first section 20 with inner teeth 21. To form the interlocked connection with the planetary carrier 4 the inner teeth 21 engage with a complementary array of outer tooth on the planetary carrier 4. In addition, the bridge pot 6 has a second section 30 with outer teeth 31. To form an interlocked connection with the housing 7, the outer teeth 31 engage with complementary inner teeth of the housing 7. The contour of the bridge pot 6 essentially follows the contour of the planetary gearset 1, so that the planetary gearset 1 is enclosed by the bridge pot 6 at least on an outer periphery and at an end.

The first section 20 of the bridge pot 6, on which the inner teeth 21 are formed in the example shown, has a larger diameter than the second section 30, on which in this example the outer teeth 31 are formed. The teeth 21, 31 are preferably in the form of spline teeth, which simplifies the fitting of the bridge pot 6 onto the housing 7 and the planetary carrier 4. The first section 20 and the second section 30 are connected integrally with one another, so that the bridge pot 6 is a monolithic structure.

Several planet gear bolts 16 are mounted non-rotatably on the housing-mounted planet carrier 4, with each planet gear bolt 16 rotatably supporting one of the planet gears 5 of the planet gear set 1, as shown by way of example in FIG. 2. A radial shaft bearing, such as a needle bearing or cylindrical roller bearing, can be provided between the planet gear bolt 16 and the planet gear 5 to support the planet gear 5. The planet gear bolt 16 can be secured against rotation by means of a pin that extends radially through the planet carrier 4 and the planet gear bolt 16, as also shown by way of example in FIG. 2.

In addition, FIG. 2 also shows that the ring gear 3 is preferably connected directly and rotationally fixed to the drive output shaft 15 by way of a ring gear carrier 14. The rotor 12 has a rotor carrier 13 which is mounted rotatably on the housing 7 by at least one roller bearing 17. The rotor 12 is connected directly and rotationally fixed to the sun gear 2 by the rotor carrier 13 (see FIG. 1).

Radially outside the radial bores 19 which are provided for the passage of lubricant into the sun gear 2, a lubricant distribution device 18 is arranged. The lubricant distribution device guides liquids and is arranged in a fixed position on the planetary gearwheel bolts 16 and/or on the planetary carrier 4. Thus, the lubricant distribution device 18 is also fixed to the housing, i.e., it does not rotate. The lubricant distribution device 18 is arranged with inlet openings around the outer periphery of the sun gear 2 in such manner that the lubricant squirting out of the radial holes 19 is captured directly by the lubricant distribution device 18. The lubricant distribution device 18 guides the captured lubricant via guide vanes provided for that purpose to outlet openings of the device 18, which are formed transversely to the inlet openings. Each outlet opening is connected fluidically to a central bore 22 in the planetary gearwheel bolt 16 concerned. In that way the captured lubricant is passed on via the central bore 22 to the rotatably mounted planetary gearwheels 5.

In particular, in the planetary gearwheel bolts 16 a number of radial bores distributed around the periphery are arranged, so that by virtue of gravity the lubricant tries to flow down, out of the central bore 22. In this way the tooth engagement area between the planetary gearwheel 5 concerned, the sun gear 2 and the ring gear 3 is lubricated and cooled efficiently. Further devices for conveying the lubricant into the static planetary gearwheel bolts 16 are not needed. This further reduces assembly cost and effort, and saves material, weight and fitting space.

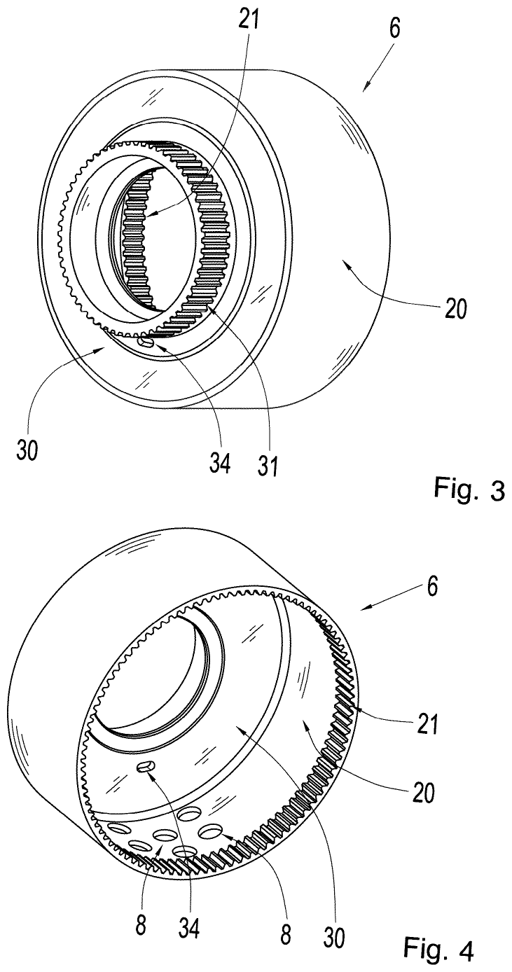

FIGS. 3 and 4 show different perspective representations of the bridge pot 6 according to FIGS. 1 and 2. From those figures the pot-shaped structure of the bridge pot 6 can be seen. The first section 20 is essentially sleeve-shaped and is designed to extend along an outer periphery of the planetary gearset 1, axially from one end of the planetary gearset 1 to the other end thereof. The inner teeth 21 for connecting the planetary carrier 4 to the bridge pot 6 are formed at a free end of the first section 20. The second section 30 is essentially annular disk-shaped and is designed to extend along an end face of the planetary gearset 1 essentially in the radial direction. The outer teeth 34 for connecting the bridge pot 6 to the housing 7 are formed at a free end of the second section 30. The first section 20 and the second section 30 are connected integrally to one another, so that the bridge pot 6 is formed monolithically. For example, the bridge pot 6 can be made by deformation, or in particular as an aluminum pressure-diecasting.

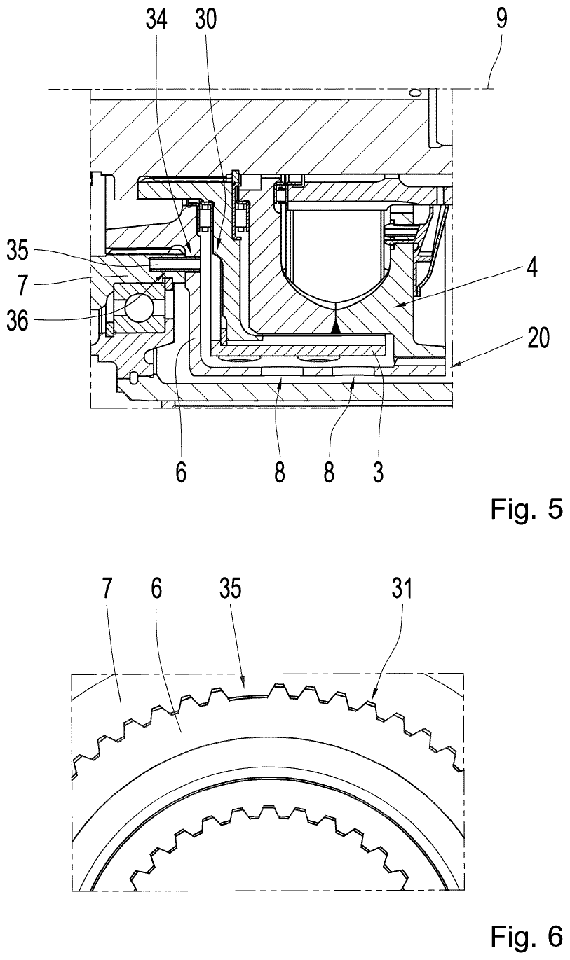

As shown in FIGS. 3 and 4 the bridge pot 6 also comprises a positioning element 34, here in the form of a recess 34 which serves for the correct orientation of the bridge pot 6 on the housing 7 in a predetermined position. This recess 34, which will be described further with reference to FIG. 5, is formed in the second section 30.

As shown in FIG. 4, the bridge pot 6 also comprises one or more perforations 8 in the first section 20 to allow the passage of lubricant. The perforations 8 are provided so that lubricant passing through the planetary gearset 1 can flow out of the bridge pot 6. In that way an accumulation of lubricant in the bridge pot 6 can be prevented, which reduces the lubricant splash-losses taking place in the planetary gearset 1. For that purpose, in the assembled and ready-for-operation condition the perforations are directed downward and/or provided on an underside of the bridge pot 6.

FIG. 5 shows a longitudinal section of another part of the planetary transmission in FIGS. 1 and 2. This part consists of a lower portion of the planetary transmission in the assembled and ready-to-operate condition. In the recess 34 formed in the second section 30 of the bridge pot 6, which serves for the alignment of the bridge pot 6 on the housing 7, in this case a further positioning element in the form of a pin 35 is arranged. The pin 35 extends farther into a hole 36 provided in the housing 7 provided for it, and is thereby held in the housing 7. In that way the bridge pot 6 is always correctly aligned in the housing 7. Thus, the recess 34, the pin 35 and the hole 36 serve as positioning elements to ensure positionally correct orientation of the bridge pot 6 on the housing 7. This positioning takes place in such manner that in the ready-to-operate condition of the planetary transmission the perforations 8 of the bridge pot 6 are located on the underside of the planetary transmission. Accordingly, the lubricant passing though the planetary gearset 1 can flow down out of the bridge pot 6.

FIG. 6 shows a cross-sectional representation of part of an alternative embodiment of the planetary transmission in FIG. 1, in the area of the second section 30 of the bridge pot 6. The section shown is part of the outer teeth 31 of the bridge pot 6. In this case, instead of the pin 35 shown in FIG. 5 and the recess 34, special teeth with a tooth gap 35 for the outer teeth 31 are provided. Here, the outer teeth 31 with the tooth gap 35 serve as the positioning element for the positionally correct orientation of the bridge pot 6 on the housing 7. This tooth gap 35 has a different shape from the other tooth gaps of the outer teeth 31. The tooth gap 35 fits a complementarily shaped tooth of the counter tooth array (the inner teeth) on the housing 7, and in the assembled condition is filled by that tooth. Thus, the tooth concerned forms the associated positioning element of the housing 7. In that way the bridge pot 6 can only be inserted into the housing 7 in the predetermined position, in which the perforations 8 of the bridge pot 6 are at the bottom. In other respects, the explanations relating to the previous figures also apply to the embodiment in FIG. 6.

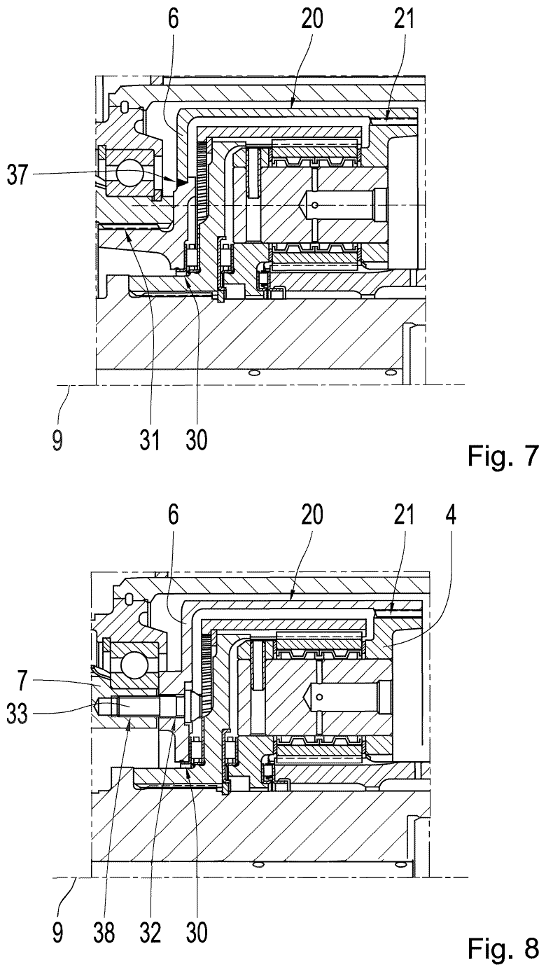

FIG. 7 shows a sectioned representation of part of the planetary transmission in FIG. 1 according to a further embodiment. In this case the bridge pot 6 is made in two parts. The first section 20 and the second section 30 of the bridge pot 6 are connected to one another by a material-merged joint. In that way the first section 20 can be made from sheet metal and the second section 30 can be made as an ancillary component, for example by a machining process. In this case a weld seam 37 is formed between two radially extending areas of the sections 20 and 30 on the bridge pot 6. In other respects, the explanations relating to the previous figures also apply to the embodiment in FIG. 7.

FIG. 8 shows a schematic sectioned representation of part of the planetary transmission in FIG. 1, according to another embodiment. In this case, for example, the bridge pot 6 is a monolithic structure. The bridge pot 6 comprises the first section 20 with its inner teeth 21 for connection to the planetary carrier 4. In the second section 30 a plurality of bores 32 are provided. These bores 32 are preferably distributed uniformly in the circumferential direction. They serve for the passage in each case of a respective fixing element 33 which serves for the rotationally fixed connection of the bridge pot 6 to the housing 7. In the figure only one of the fixing elements 33 is shown. The fixing element 33 is in the form of a screw, which is screwed into an associated threaded bore 38 in the housing 7. In that way the bridge pot 6 is screwed firmly to the housing 7. This embodiment can have advantages when fitting the bridge pot 6 to the housing 7, since compared with the embodiment of FIG. 2 the outer teeth 31 on the bridge pot 6 can be omitted. Furthermore, in this case the roller bearing shown in FIG. 8 for fitting the rotor of the electric drive machine can at the same time be clamped firmly between the housing 7 and the bridge pot 6, whereby the roller bearing is fixed axially. In other respects, the explanations relating to the previous figures also apply to the embodiment in FIG. 8.

### INDEXES

1 Planetary gearset
2 Sun gear
3 Ring gear
4 Planetary carrier
5 Planetary gearwheel
6 Bridge pot
7 Housing
8 Perforation
9 Rotation axis
10 Drive machine
11 Stator
12 Rotor
13 Rotor carrier
14 Ring gear carrier
15 Drive output shaft
16 Planetary gearwheel bolts
17 Roller bearing
18 Lubricant distribution device
19 Radial bore
20 First section
21 Inner teeth
22 Central bore
30 Second section
31 Outer teeth
32 Bore
33 Fastening element
34 Positioning element (recess)
35 Positioning element (pin, tooth gap)
36 Bore
17 Weld seam
38 Threaded bore

1. A planetary transmission with a planetary gearset (1) comprising:
a sun gear (2) configured to be drivingly connected to a drive machine (10);
a ring gear (3) configured to be drivingly connected to a drive output shaft (15); and
a planetary carrier (4) with a plurality of planetary gearwheels (5) arranged at least indirectly on it, wherein the planetary carrier (4) is held immobilized on a housing (7),
wherein the planetary carrier (4) is connected rotationally fixed to the housing (7) by means of a bridge pot (6) which spans axially across the planetary gearset (1).

2. The planetary transmission according to claim 1, wherein the bridge pot (6) comprises a first section (20) for connection to the planetary carrier (4) and a second section (30) for connection to the housing (7).

3. The planetary transmission according to claim 2, wherein the first section (20) has a larger diameter than the second section (30).

4. The planetary transmission according to claim 2, wherein the first section (20) and the second section (30) are arranged at axially opposite ends of the bridge pot (6).

5. The planetary transmission according to claim 2, wherein the first section (20) for connecting the bridge pot (6) to the planetary carrier has inner teeth (21).

6. The planetary transmission according to claim 5, wherein the second section (30) for connecting the bridge pot (6) to the housing (7) has outer teeth (31) and/or at least one bore (32) for the passage of a fixing element (33).

7. The planetary transmission according to claim 2, wherein at least one perforation (8) is defined in the first section (20), the at least one perforation (8) configured for the passage of lubricant.

8. The planetary transmission according to claim 1, wherein the bridge pot (6) comprises at least one positioning element (34, 35) configured for aligning the bridge pot (6) relative to the housing (7).

9. The planetary transmission according to claim 1, comprising an electric drive machine (10) and wherein the planetary gearset (1) is arranged radially inside the electric drive machine (10).

10. A drive unit for a motor vehicle drivetrain, comprising:
a housing (7);
an electric drive machine (10) arranged in an inside space of the housing; and
the planetary transmission of claim 1 arranged in the inside space.
